(19) United States
(12) Patent Application Publication
(10) Pub. No.: US 2023/0333557 A1
(43) Pub. Date: Oct. 19, 2023

(54) DATA PROCESSING METHOD FOR OBJECT DETECTION AND IDENTIFICATION AND AUTONOMOUS DERIVING DEVICE THEREFOR

(71) Applicants: Joonyoung Hong, Seoul (KR); Jiun Choi, Seoul (KR)

(72) Inventors: Joonyoung Hong, Seoul (KR); Jiun Choi, Seoul (KR); Jaeyeon Park, Seoul (KR); Juhyeon Kim, Seoul (KR)

(73) Assignees: Joonyoung Hong, Seoul (KR); Jiun Choi, Seoul (KR)

(21) Appl. No.: 18/135,199

(22) Filed: Apr. 17, 2023

(30) Foreign Application Priority Data
Apr. 15, 2022 (KR) 10-2022-0047053
Nov. 10, 2022 (KR) 10-2022-0149940

(51) Int. Cl. G05D 1/02; G06V 20/58; G06V 10/82; G06T 7/20

(52) U.S. Cl. CPC G05D 1/021; G06T 7/20; G06V 10/82; G06V 20/58

(57) ABSTRACT

A method for controlling a vehicle based on object identification for autonomous driving according to the disclosure of this document includes obtaining sensor data based on sensors positioned on a vehicle, performing object identification based on a result of applying the sensor data to a machine learning model, adjusting a control parameter of the vehicle based on a result of the object identification, wherein performing the object identification comprises receiving pairing data through a network, wherein the object identification is performed further based on the pairing data. Based on this, it is possible to increase the accuracy of object identification in the blind area.

### CROSS-REFERENCE TO RELATED APPLICATIONS

This application claims the priority under 35 U.S.C § 119 on KR Application No. 10-2022-0047054 filed on Apr. 15, 2022, and KR Application No. 10-2022-0149940 filed on Nov. 10, 2022, the entire contents of which are hereby incorporated by reference.

### BACKGROUND

### Technical Field

This document relates to image processing technology, and more particularly, to a data processing method for object detection and identification.

### Description of the Related Art

Autonomous driving systems are usually performed based on multiple sensors (e.g., camera sensor, radar sensor, lidar sensor, or ultrasonic sensor, etc.) Information/data acquired by each sensor is used to understand the surrounding environment of the vehicle and is used to control the vehicle. Vision sensors can be used to identify objects from captured images. A distance sensor may be used to determine the distance of a detected object.

Various deep learning-based (or neural network-based) techniques are being used to accurately recognize the surrounding environment for autonomous driving, and information/data obtained from the plurality of sensors is being used for the above deep learning.

Due to the nature of autonomous driving, it is required that the accuracy of recognizing surrounding objects is considerably high, but in order to further enhance the performance of deep learning, more information/data is required and the amount of calculation also increases considerably. In this case, real-time data processing for autonomous driving becomes difficult. Therefore, for smooth autonomous driving, a method capable of further increasing the accuracy of recognizing surrounding objects while maintaining or reducing complexity is required.

### SUMMARY

A technical object of the present disclosure is to provide a data processing method and apparatus for object recognition.

Another technical object of the present disclosure is to provide a data processing method and apparatus for autonomous driving.

Another technical object of the present disclosure is to provide a method and apparatus for identifying an object based on a sound sensor.

Another technical object of the present disclosure is to provide a method and apparatus for identifying an object based on vision pairing.

Another technical object of the present disclosure is to provide a method and apparatus for further increasing object identification accuracy while maintaining or reducing complexity.

According to an embodiment of the present disclosure may comprise obtaining sensor data based on sensors positioned on a vehicle, performing object identification based on a result of applying the sensor data to a machine learning model, adjusting a control parameter of the vehicle based on a result of the object identification, wherein performing the object identification comprises receiving pairing data through a network, wherein the object identification is performed further based on the pairing data.

The pairing data may include object information obtained from an external vehicle or an external device

The pairing data may include object information on an object that is not identified from the sensor data obtained from the sensors positioned on the vehicle.

A first object and a second object may be identified through the performing the object identification according to the present document, wherein the first object is identified from the sensor data obtained from the sensors positioned on the vehicle, and the second object is identified from the pairing data, and wherein the second object is different from the first object.

Based on (i) at least one of a location, velocity or acceleration of the second object at a first time point and (ii) a delay time between a second time point and the first time point, location information of the second object at the second time point may be updated.

The location information of the second object may be updated based on equations 1 through 8 of the present document.

Performing the object identification according to the present document may comprise identifying n objects from the sensor data, identifying m objects from the pairing data, and among m objects, updating k objects that are not overlapped with the n objects as valid objects.

According to an embodiment of the present disclosure may comprise obtaining sensor data based on sensors positioned on a vehicle, wherein the sensors include a sound sensor, performing sound identification based on a result of applying the sensor data to a machine learning model, identifying at least one of a sounding object or a sounding direction associated with the identified sound, adjusting a control parameter of the vehicle based on the identified sound and at least one of the sounding object or the sounding direction.

Here, the control parameter may be adjusted based on a comparison between the sounding direction and the driving direction of the vehicle.

According to an embodiment of the present disclosure, accuracy of object identification may be increased.

According to an embodiment of the present disclosure, autonomous driving performance may be improved through efficient object identification.

According to an embodiment of the present disclosure, a vehicle may be controlled by recognizing a surrounding environment based on ambient sound.

According to an embodiment of the present disclosure, information/data not currently obtained from a sensor of a vehicle may be collected and used for autonomous driving.

### BRIEF DESCRIPTION OF THE DRAWINGS

FIG. 1 is an example schematically illustrating an autonomous driving system to which embodiments according to the present disclosure may be applied.

FIG. 2 schematically illustrates an example of a method for training a machine learning model to which embodiments according to the present disclosure may be applied.

FIG. 3 schematically illustrates an example of an object recognition and vehicle control method to which embodiments according to the present disclosure may be applied.

FIG. 4 schematically illustrates an example of an object recognition and vehicle control method to which embodiments according to the present disclosure may be applied.

FIG. 5 shows an example of a feature map that can be used in embodiments of the present disclosure.

FIG. 6 shows an example of a neural network.

FIG. 7 exemplarily shows a schematic structure of a CNN.

FIG. 8 shows a case where a police car calls an autonomous vehicle.

FIG. 9 shows a case where an ambulance passes by sounding a siren.

FIG. 10 illustratively illustrates autonomous driving based on sound recognition according to an exemplary embodiment.

FIG. 11 and FIG. 12 show an example of a case where an autonomous vehicle does not recognize other vehicles on a driving route.

FIG. 13 and FIG. 14 show an example of not recognizing the overturned vehicle in front.

FIG. 15 exemplarily illustrates a vision pairing-based autonomous driving control method according to another embodiment.

FIG. 16 and FIG. 17 illustratively show a time delay and a positional difference of an object from a second autonomous driving device to a first autonomous driving device.

FIG. 18 illustrates an example of detecting/identifying an object vehicle based on vision pairing.

FIG. 19 shows an example of a pairing region-based pairing operation.

FIG. 20 exemplary shows a pairing region.

FIG. 21 shows an example of a pairing region-based pairing operation.

FIG. 22 shows an example of a pairing request and acceptance procedure.

### DETAILED DESCRIPTION

The disclosure of the present document may have various changes and various embodiments and specific embodiments are illustrated in the drawings and described in detail. Terms used in the present document are only used to describe specific embodiments, and are not intended to limit the technical spirit of the method presented in the present document. Expressions in the singular include “at least one” unless the context clearly dictates otherwise. In this document, the terms “comprise” or “having” are intended to indicate that there is a feature, number, step, operation, component, part, or combination thereof described in the document, but it should be understood that the presence or addition of one or more other features, numbers, steps, operations, components, parts, or combinations thereof is not precluded.

On the other hand, each component in the drawings described in the present document is shown independently for the convenience of description of different characteristic functions, and each component does not have to be implemented as separate hardware or separate software. For example, two or more of the components may be combined to form one component, or one component may be divided into a plurality of components. Embodiments in which each component is integrated and/or separated are also included in the scope of the disclosure of this document as long as they do not depart from the essence of the method disclosed in this document.

Embodiments disclosed herein include a processor, process, device, system, and/or computer readable storage configured to execute instructions stored and/or provided by an associated memory. It can be implemented in a variety of ways, including a computer program product embodied by a medium. In this document, ‘processor’ may refer to one or more devices, circuits, and/or processing cores configured to process data such as computer program instructions.

In the present document, the term “/” and “,” should be interpreted to indicate “and/or.” For instance, the expression “A/B” may mean “A and/or B.” Further, “A, B” may mean “A and/or B.” Further, “A/B/C” may mean “at least one of A, B, and/or C.” Also, “A/B/C” may mean “at least one of A, B, and/or C.”

Further, in the document, the term “or” should be interpreted to indicate “and/or.” For instance, the expression “A or B” may comprise 1) only A, 2) only B, and/or 3) both A and B. In other words, the term “or” in the present document should be interpreted to indicate “additionally or alternatively.”

Further, the parentheses used in the present document may mean “for example”. Specifically, in case that “sensor (vision sensor)” is expressed, it may be indicated that “vision sensor” is proposed as an example of “sensor”. In other words, the term “sensor” in the present document is not limited to “vision sensor”, and “vision sensor” is proposed as an example of “sensor”. Further, even in case that “sensor (i.e., vision sensor)” is expressed, it may be indicated that “vision sensor” is proposed as an example of “sensor.”

In the present document, technical features individually explained in one drawing may be individually implemented or simultaneously implemented.

The present document may be about data processing for autonomous driving. For example, the method/embodiment disclosed in this document can be applied to various methods for autonomous driving.

In the present document, various embodiments related to data processing for autonomous driving are presented, and unless otherwise specified, the above embodiments may be performed in combination with each other.

In the present document, a video may mean a set of a series of images over time. A picture may generally mean a unit representing one image in a specific time period. A picture or video can be based on various color formats. For example, a picture or video may be based on an R, G, B color format, or a Y, U, V color format.

A pixel or pel may mean a minimum unit constituting one picture (or image). Also, ‘sample’ may be used as a term corresponding to a pixel. A sample may generally represent a pixel or pixel value, may represent only a pixel/pixel value of a luma component, or only a pixel/pixel value of a chroma component. Alternatively, the sample may represent a pixel/pixel value of a specific component among R, G, and B.

Hereinafter, embodiments of this document will be described in more detail with reference to the accompanying drawings. Hereinafter, the same reference numerals may be used for the same components in the drawings, and redundant descriptions of the same components may be omitted.

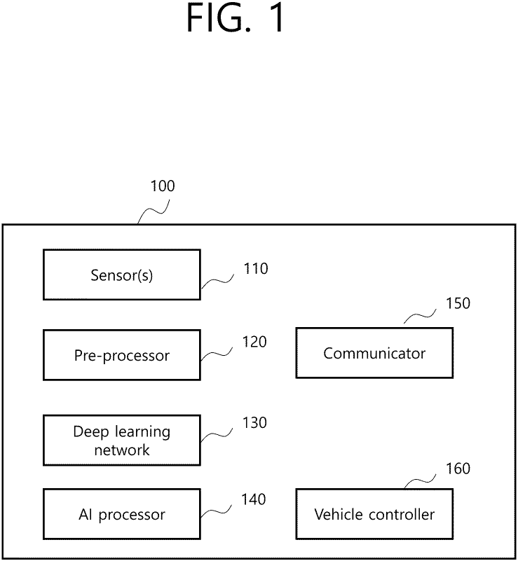

FIG. 1 is an example schematically illustrating an autonomous driving system to which embodiments according to the present disclosure may be applied. The autonomous driving system includes data collection and processing for training machine learning models for autonomous driving, as well as other components that may be used together for autonomous driving and/or driver-assisted operation of a vehicle. In embodiments herein, an autonomous driving system may be installed in a vehicle or any transportation mean. The vehicle’s data can be used to train and improve the autonomous driving characteristics of that vehicle, other vehicles, or other transportation means. Meanwhile, an autonomous driving device or a deep learning device according to embodiments of the present document may not include at least one of the components disclosed in FIG. 1. For example, the sensor(s) 110 may be provided separately from the autonomous driving device or the deep learning device. For example, the communicator 150 and/or the vehicle controller 160 may be provided separately from the autonomous driving device or the deep learning device. The autonomous driving system may be called a deep learning system. The autonomous driving system may be referred to as an autonomous driving device. The autonomous driving device may be referred to as a deep learning device. In this document, deep learning may be used interchangeably with machine learning and/or neural networks.

Referring to FIG. 1, the autonomous driving system 100 includes sensor(s) 110, a pre-processor 120, a deep learning network 130, an artificial intelligence (AI) processor, 140, a vehicle controller 160, and a communicator 150. The components may be connected electrically or wired/wireless. The communicator 150 may communicate with an external vehicle (or means of transportation) or a base station through a network. Here, the communicator 150 may perform communication based on various communication techniques such as vehicle to everything (V2X), device to device (D2D), 4G, 5G, 6G, or next-generation communication techniques. The communication may include broadcast communication and/or may include unicast communication.

The sensor(s) 110 may include one or more sensors. The sensors may be attached to the vehicle at different locations on the vehicle or in different orientations. The sensors may include vision sensor(s), sound sensor(s) and/or distance sensor(s). A vision sensor may be referred to as an image sensor. The sensors may include, for example, camera sensors, radar sensors, lidar sensors, inertia sensors, odometry sensors, location sensors and/or ultrasonic sensors. The position sensor may include a global position system (GPS) sensor or the like for determining the position of the vehicle and/or a change in position. The sensors may include one or more cameras that capture the road surface the vehicle is moving on. The sensors may include one or more cameras that capture surrounding objects. The surrounding objects may include not only vehicles, but also transportations such as bicycles, people, and animals.

The pre-processor 120 may be used to preprocess sensor data obtained from the sensor(s) 110. The pre-processor 120 may divide the sensor data into one or more components or combine a plurality of components of the sensor data. For example, the pre-processor 120 may combine sensor data obtained from sensors of the same type or may combine sensor data obtained from sensors of different types. The pre-processor 120 may be used to remove or modify warping. Alternatively, the pre-processor 120 may be used to adjust the resolution of a portion of an image or sharpen an object edge. Alternatively, the pre-processor 120 may be used to remove noise or extract features from the sound obtained from a sensor.

The deep learning network 130 may determine vehicle control parameters including analyzing the driving environment to determine lanes, drivable spaces, obstacles and/or objects, and the like. For example, the deep learning network 130 may be trained on inputs such as sensor data and outputs may be provided to the vehicle controller 140. Deep learning network 130 may include one or more neural networks. The one or more neural networks may include, for example, one or more convolution neural networks (CNNs) and/or one or more recursive neural networks (RNNs). The deep learning network 130 may identify/predict lanes, drivable spaces, obstacles, and/or objects, and deliver related information to the AI processor 140, the vehicle controller 160, or the communicator 150. Here, identifying an object may include detecting the object and/or detecting characteristics of the object. The characteristics of the object may include at least one of distance, position, speed, direction, size, shape, color, and type of the object. The type of object may indicate whether the object is one of candidates including a car, a bicycle, a person, a dog, or a cat. Alternatively, when the object is a car, the type of the object may indicate whether the object is one of candidates including a large truck, a passenger car, a police car, an ambulance, or a fire truck.

The AI processor 140 may drive and control the deep learning network 130. An AI processor can also be integrated with deep learning networks. The AI processor 140 may transfer the output of the deep learning network 130 to the vehicle controller 160, or the AI processor 140 may determine a control parameter based on the output of the deep learning network and may transfer it to the vehicle controller 160. AI processor 140 may be coupled to a memory. The memory may be configured to provide instructions to the AI processor 140, wherein the instructions, when executed, cause the AI processor 140 to perform deep learning analysis on the received input sensor data and determine a machine learning result for use in autonomous driving. AI processor 140 may be used to process sensor data in preparation for making the data available as training data.

The vehicle controller 160 may control the vehicle or output a control command based on the output of the deep learning network 130 and/or the output of the AI processor 140. The vehicle controller 160 may perform vehicle control for autonomous driving or driving assistance. The vehicle controller 160 may adjust vehicle speed, acceleration, steering, braking, and the like. The vehicle controller 160 may control vehicle lights, wipers, horns, and the like. The sensor may be provided inside the vehicle as well as outside the vehicle, and the sensor inside the vehicle may recognize the occupant (or driver) and perform vehicle control based on the occupant (or driver).

The communicator 150 includes a communication interface for transmitting and/or receiving data through a network. The communicator 150 may receive an update about the deep learning network including the updated machine learning model and transmit it to the deep learning network 130. In this case, the deep learning network 130 may update model parameters. For example, the communicator 150 may receive pre-trained deep learning model parameters from a remote server and transmit them to the deep learning network 130. The communicator 150 may be used to receive an update for instructions and/or operation parameters for the sensor(s) 110, the pre-processor 120, the deep learning network 130, the AI processor 140, and/or the vehicle controller 160. The communicator 150, as described below, may transmit or receive external environment information (including object information, lane information, or obstacle information) from a remote server or a nearby vehicle. Here, the external environment information may include sensor data and/or information detected from the sensor data through deep learning.

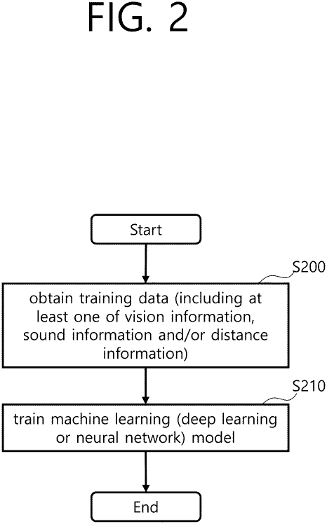

FIG. 2 schematically illustrates an example of a method for training a machine learning model to which embodiments according to the present disclosure may be applied. The machine learning model training method disclosed in FIG. 2 may be performed outside the vehicle, such as a remote server, or inside the vehicle. For example, when the method is performed inside a vehicle, the vehicle may further perform the machine learning training method for additional training to a pre-trained model. The machine learning model derived by the training method disclosed in FIG. 2 may be provided to the deep learning network described above in FIG. 1.

Referring to FIG. 2, the training device acquires training data (S200). The training data may include sensor data or information acquired through a sensor or the like. The training data may include vision information, sound information and/or distance information. The training data may further include location information. The training data includes data/information obtained through at least one of a camera sensor, a radar sensor, a Lidar sensor, an inertia sensor, an odometry sensor, a location sensor, and/or an ultrasonic sensor. The vision information is information related to vision and may include data/information obtained through a camera sensor, a radar sensor, or a lidar sensor. The training device may be provided on a remote server, vehicle or etc. The training device may include, for example, the above-described deep learning network.

The training device trains a machine learning model based on the training data (S210). The machine learning model may include one or more neural networks. The one or more neural networks may include, for example, one or more convolution neural networks (CNNs) and/or one or more recursive neural networks (RNNs). Machine learning models can be trained to predict three-dimensional representations of features from input images. Machine learning models can be trained to predict sound characteristics from input sounds. The characteristics of the sound may include the type, direction, and distance of the sound. For example, the machine learning model may separately include a vision/image training model and a sound training model. As another example, the machine learning model may integrally include a vision/image training model and a sound training model.

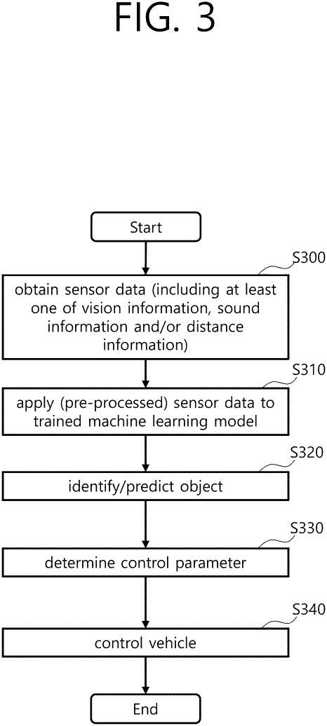

FIG. 3 schematically illustrates an example of an object recognition and vehicle control method to which embodiments according to the present disclosure may be applied. Some of the steps in FIG. 3 may be omitted or incorporated into other steps. For example, S340 may be omitted. For example, S300 to S320 may be performed by the deep learning network and/or AI processor of FIGS. 1, and S330 to S340 may be performed by the vehicle controller of FIG. 1. Alternatively, S330 may be performed by the deep learning network of FIG. 1.

The autonomous driving device acquires sensor data (S300). The autonomous driving device may receive the sensor data from the outside or obtain the sensor data from the connected sensor(s). The sensor data may be raw data or preprocessed data. The sensor data may include data/information obtained through at least one of a camera sensor, a radar sensor, a Lidar sensor, an inertia sensor, an odometry sensor, a location sensor, and/or an ultrasonic sensor.

The autonomous driving device applies the sensor data to the trained machine learning model (S310). In this case, sensor data may be preprocessed and applied to the trained machine learning model.

The autonomous driving device identifies/predicts an object (S320). S320 may be integrated with S310 or performed separately. Objects can be identified and predicted through the trained machine learning model. Object information may include identification/predicted information about the object. Here, identifying an object may include detecting the object and/or detecting a characteristic of the object. The characteristics of the object may include at least one of distance, position, speed, direction, size, shape, color, and type of the object. The type of object may indicate whether the object is one of candidates including a car, a bicycle, a person, a dog, or a cat. Alternatively, when the object is a car, the type of the object may indicate whether the object is one of candidates including a large truck, a passenger car, a police car, an ambulance, or a fire truck.

Although not shown, the autonomous driving device may generate a feature map. The autonomous driving device may generate a feature map based on the identified/predicted object. A feature map may include a 2D map or a 3D map. The feature map may be represented based on a plan view or a perspective view.

The autonomous driving device determines a control parameter (S330). The autonomous driving device may determine the control parameter based on the result of S320. The autonomous driving device may determine the control parameter based on the feature map. One or more autonomous driving features may be derived by various aspects. For example, the speed, acceleration, steering, and braking of the vehicle may be adjusted. The autonomous driving device may generate control parameters for vehicle lights, wipers, horns, and the like. The sensors may be provided not only outside the vehicle but also inside the vehicle, and the sensor inside the vehicle may recognize the occupant (or driver) and generate vehicle control parameters based on the occupant (or driver).

The autonomous driving device controls the vehicle (S340). S340 may be integrated into S330 or may be performed separately. The vehicle may be controlled based on the control parameter.

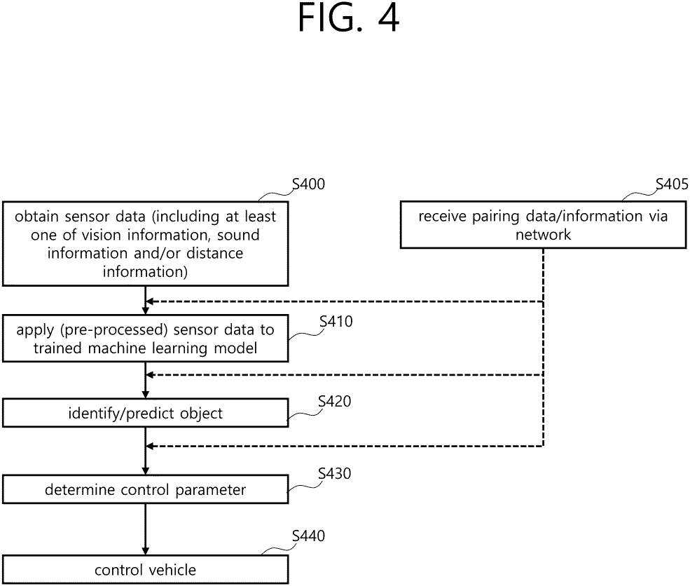

FIG. 4 schematically illustrates an example of an object recognition and vehicle control method to which embodiments according to the present disclosure may be applied. Some of the steps in FIG. 4 may be omitted or incorporated into other steps. For example, S440 may be omitted. For example, S400 to S420 may be performed by the deep learning network and/or AI processor of FIG. 1, and S430 to S440 may be performed by the vehicle controller of FIG. 1. Alternatively, S430 may be performed by the deep learning network of FIG. 1. S405 may be performed by the communicator of FIG. 1.

Referring to FIG. 4, S400, S410, S420, S430, and S440 may include the contents described above in S300, S310, S320, S330, and S340 in FIG. 3, and the differences are mainly described as follows.

The autonomous driving device receives pairing data/information through a network (S405). The pairing data may include at least one of center data obtained from another vehicle, object recognition information (including object characteristic information), and feature map information. The pairing data may be used interchangeably with pairing information. When the autonomous driving device is referred to as a first autonomous driving device, another autonomous driving device (hereinafter referred to as a second autonomous driving device) may obtain second object information from second sensor data. The second autonomous driving device may generate a second feature map based on the second object information. The pairing data may be used as an input of S410, or may be combined with an output of S410 or an output of S420.

For example, the first autonomous driving device may perform S410 further based on the second sensor data.

As another example, the first autonomous driving device derives first object information based on S410, and may provide modified/updated object information based on the received second object information and the derived first object information. In this case, the modified/updated object information may differ in at least one of the number and/or characteristics of objects included in the first object information. For example, information on a specific object derived from second object information may be reflected in the first object information to derive the modified/updated object information. Specifically, for example, when information on a detected specific car or specific person present in the second object information does not exist in the first object information (or exists but is contaminated or incomplete), information on the specific car or the specific person detected in the second object information is reflected in the first object information, and thus the modified/updated object information may be derived.

As another example, the first autonomous driving device derives a first feature map, and may derive modified/updated feature map information based on the received information on the second feature map and the information on the derived first feature map. In this case, the modified/updated feature map may further include a specific object (or characteristic of the specific object) derived from the second feature map and not derived from the first feature map.

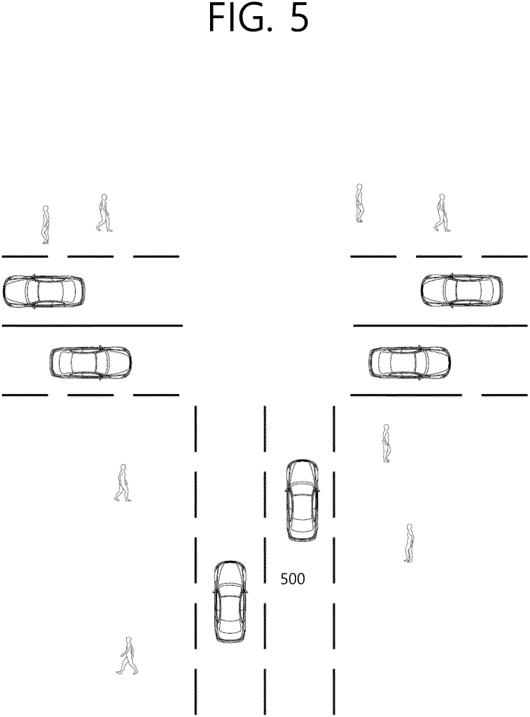

FIG. 5 shows an example of a feature map that can be used in embodiments of the present disclosure.

Referring to FIG. 5, a vehicle 500 may represent a vehicle equipped with an autonomous driving device according to an embodiment of the present document. As described above, the feature map may schematically represent the neighboring environment. The feature map may include neighboring object information. The feature map may include, for example, information about detected neighboring vehicles, information about neighboring people, information about neighboring lanes, information about traffic lights, and the like. As described above, the object information may include identification/predicted information about the object. Here, identifying an object may include detecting the object and/or detecting a characteristic of the object. The characteristics of the object may include at least one of distance, position, speed, direction, size, shape, color, and type of the object. The type of object may indicate whether the object is one of candidates including a car, a bicycle, a person, a dog, or a cat. Alternatively, when the object is a car, the type of the object may indicate whether the object is one of candidates including a large truck, a passenger car, a police car, an ambulance, or a fire truck.

Meanwhile, machine learning models based on learning data are already being used in many fields, and among them, CNNs show excellent performance in the field of image recognition. The machine learning model may be based on a neural network.

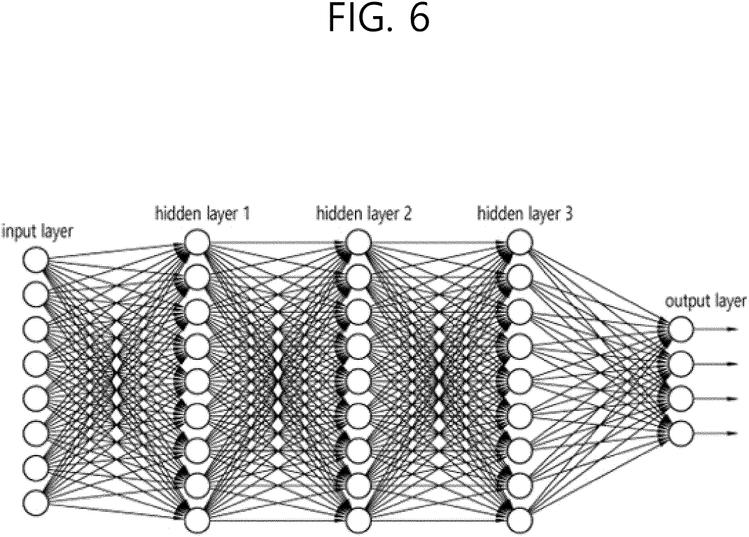

The neural network may be a class of algorithms based on the idea of interconnected neurons. In a general neural network, a neuron may include a data value, and the pre-defined strength for each connection and whether the sum of the connections for each specific neuron exceeds a pre-defined threshold value, depending on the connection, each data value can affect the value of the connected neuron. By determining appropriate connection strengths and thresholds (a process also referred to as “training”), neural networks can effectively recognize images and text. To make the connections between groups clearer, and for each operation of a value, neurons can often be grouped into “layers”. Referring to FIG. 6, for example, a general neural network may include three types of layers. The three types of layers may include an input layer, a hidden layer, and an output layer.

The input layer may represent a layer providing an input to the neural network model. The number of neurons of the input layer may be equal to the number of features of data. For example, the number of neurons of the input layer may be equal to the number of samples of the input picture.

The hidden layer may represent a layer between the input layer and the output layer. An output of the input layer may be supplied to the hidden layer. Also, the neural network may include one or more hidden layers according to the size of the model and data. In general, the hidden layer may include more neurons than the number of features. That is, in general, the hidden layer may include more neurons than the number of neurons of the input layer. Also, when a plurality of hidden layers exist, the hidden layers may include different numbers of neurons. The output of each hidden layer may be calculated based on a matrix multiplication of the output of the previous layer by the learnable weights of that hidden layer, followed by an activation function that makes the network nonlinear, followed by learnable biases.

The output layer may indicate a layer including an output of the neural network model. The output of the hidden layer may be transferred to a logistic function that transforms the output of each class.

The neural network shown in FIG. 6 may represent an embodiment called a fully-connected neural network. Each neuron in a layer can be connected to a neuron in the next layer. For example, neurons in the input layer can be connected to all neurons in hidden layer 1. Also, each neuron of the hidden layer 1 may receive an input value from each neuron of the input layer. Thereafter, input values input to the neurons may be summed, and the summed values may be compared with a bias or threshold value. When the summed value is greater than the threshold value for the neuron, the summed value may be used as a value used as an input for a neuron of a next layer in the neuron. The above-described operation may be performed through various layers of the neural network, and may continue until reaching the final layer, that is, the output layer.

Meanwhile, examples of the neural network include a convolutional neural network (CNN) and a transformer-based model. The CNN and/or the transformer-based model shows excellent performance for many computer vision and machine learning problems.

Unlike neurons in the neural network that receive input values from all nodes in the previous layer, in the CNN, neurons in a specific layer include features (i.e., nodes) that are spatially or temporally close to the node in the previous layer. Input values of (image patch) may be input. That is, the CNN can operate by associating an array of values with each neuron instead of a single value. The set may also be referred to as a receptive field. The set may be derived, for example, as a 3x3 set or a 5x5 set. An MxN set may represent a set of nodes consisting of M columns and N rows. Therefore, the CNN needs a function capable of processing a local 2-D structure.

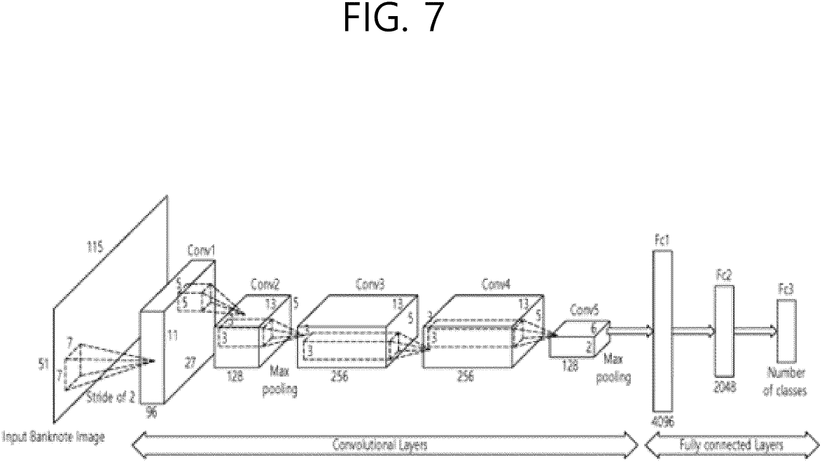

FIG. 7 exemplarily shows a schematic structure of a CNN.

Referring to FIG. 7, the CNN may include three layers described later.
convolution layer
pooling layer
Fully-Connected Layer

The convolution layer may represent a layer that calculates an output value of a node connected to a local region of an input. An output value for each node may be calculated as a dot product between a weight and a region connected to an input volume for the node.

The pooling layer may perform a down sampling operation along a spatial dimension. The down sampling may represent a process of deriving a maximum value or an average value among values of nodes of a corresponding region. Thereafter, output values of the final pooling layer may be input as input values for the fully connected layer, that is, the fully connected neural network.

Through the machine learning model as described above, it is possible to output results with significantly high accuracy. In general, a model with an accuracy of 90 to 95% is recognized as having a fairly high performance. However, since autonomous driving is directly related to human safety, higher performance and accuracy are required than conventional machine learning models. However, in order to increase the performance/accuracy of a machine learning model, more layers or a complex structure are generally required, which causes increased computational complexity and processing delay, which makes real-time processing difficult.

That is, for autonomous driving, high accuracy and real-time processing for safety must be guaranteed, but high accuracy and real-time processing are somewhat in a trade-off relationship. Therefore, in order to achieve smooth autonomous driving, a method of increasing the performance of a machine learning model while maintaining complexity to some extent is required. In addition, a method of utilizing not only vision data but also other sensor data is required for smooth autonomous driving.

Sensors or data mainly used for autonomous driving may be organized as follows, for example.

[TABLE 1]

| | Vision | Sound | Communication |
|---|---|---|---|
| Human | Image | | |
| non-Human | LIDAR, RADAR | Ultrasonic wave | Position information (GPS), V2X |

In Table 1, information that a person directly perceives in normal driving and information that is not are classified. As shown in the table, the autonomous driving system acquires various information that humans cannot directly perceive and implements it through complex processing.

In order to improve autonomous driving performance without greatly increasing complexity, at least one of ambient sound information and vision pairing information may be used in an embodiment of the present document as shown in the following table. Embodiments disclosed in this document may be combined with each other.

[TABLE 2]

| | Vision | Sound | Communication |
|---|---|---|---|
| Human | Image | Sound | |
| non-Human | LIDAR, RADAR, Vision pairing | Ultrasonic wave | Position information (GPS), V2X |

People utilize ambient sound information for driving. For example, the ambient sound information includes noises of nearby cars, sounds of nearby people, sounds of nearby bicycles, sounds of horns of nearby cars, sounds of police car sirens, sounds of police officers in police cars, sounds of ambulance sirens, and/or sounds of fire truck sirens, and the like.

However, conventional autonomous driving systems do not utilize such ambient sound information well. For example, an ultrasonic wave sensor is used, but it is mainly used for obstacle detection. If the autonomous driving car cannot utilize this ambient sound information, for example, it may not respond even if a nearby car honks. Also, the following problematic situations may arise, for example:

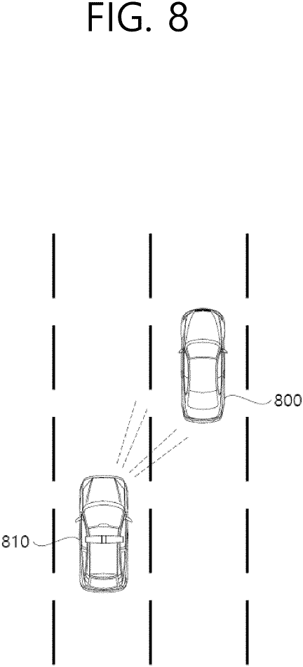

FIG. 8 shows a case where a police car calls an autonomous vehicle.

Referring to FIG. 8, a police car 810 may call an autonomous driving vehicle 800. This may be a case where the police car 810 calls the autonomous driving vehicle 800 or sends a stop signal because there is an abnormal operation or signal violation while the autonomous driving vehicle 800 is driving. In this case, in general, the autonomous driving vehicle 800 will drive ignoring the police car 810. In this case, if the police car 810 is recognized only based on vision and make the autonomous driving vehicle 800 stop, even if the police car 810 does not call the autonomous driving vehicle 800, it will stop unconditionally, which may cause a bigger problem.

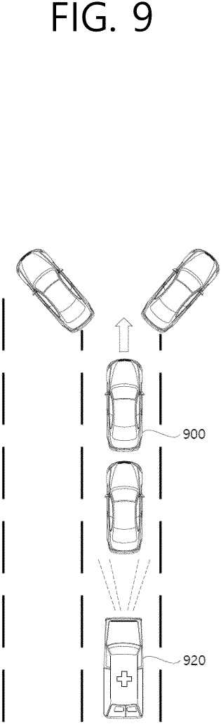

FIG. 9 shows a case where an ambulance passes by sounding a siren.

Referring to FIG. 9, an ambulance 920 may sound a siren and proceed. For example, it may be a case where the ambulance 920 is transporting an emergency patient. In this case, cars around the autonomous driving vehicle 900 may hear the siren and get out of the way to give way to the ambulance 920. In this case, if a person was driving, the vehicle may move out of the way, but since the autonomous driving vehicle 900 does not recognize that the reason why the preceding vehicle yields the road is because of the ambulance 920, the autonomous driving vehicle 900 may continue driving along the yielded road by other vehicles and may obstruct the ambulance 920′s path. In this case, in some countries, it may be punished by law in case of obstructing the path of an ambulance or other emergency transport vehicle. Meanwhile, when the autonomous driving vehicle 900 is controlled to yield the way by simply listening to the sound of a siren, a problem of giving way unnecessarily may occur even when the ambulance is on the opposite road.

Therefore, there is a need for a method that can recognize ambient sounds and control autonomous vehicles based on them. In one embodiment disclosed in this document, a sound-based autonomous driving control method is proposed.

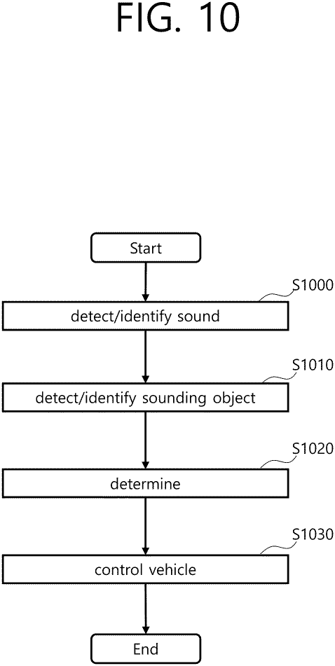

FIG. 10 illustratively illustrates autonomous driving based on sound recognition according to an exemplary embodiment. The method disclosed in FIG. 10 may be applied to the method disclosed in FIGS. 3 or 4. S1000 and S1010 may be performed by the deep learning network or AI processor of FIG. 1. S1020 and S1030 may be performed by the AI processor and vehicle controller of FIG. 1. S1000 and S1010 may be integrated. S1020 and S1030 may be integrated. An autonomous driving device may be provided in an autonomous deriving vehicle.

Referring to FIG. 10, the autonomous driving device detects/identifies sound (S1000). In this case, the autonomous driving device may detect/identify sound through a machine learning model. For example, the autonomous driving device may detect/identify whether the sound is a sound of a horn of a nearby car. As another example, the autonomous driving device may detect/identify whether the sound is a sound of a police car horn and/or a call signal for the corresponding vehicle. As another example, the autonomous driving device may detect/identify whether the sound is a siren sound of an emergency vehicle such as an ambulance or a fire truck.

The autonomous driving device detects/identifies a sounding object (or sounding position/direction) (S1010). The autonomous driving device may detect/identify which object the detected/identified sound originates from. For example, the autonomous driving device may detect/identify the sounding position/direction through sound localization, and specify an object located at the sounding location/direction to be detected/identified as a sounding object. For example, neighboring objects may be detected through object detection, and an object located in the sounding location/direction among the detected neighboring objects may be detected/identified as a sounding object. For example, the autonomous driving device may determine the characteristics of sound based on sensor data obtained from a plurality of sound sensors, and may detect/identify a sounding object (or sounding location/direction) based on it.

In addition, the autonomous driving device may detect/identify the location and/or direction of the detected/identified sound. For example, when the sounding object is not detected/identified by the vision of the autonomous driving device, the autonomous driving device may detect the sounding location and/or direction. Alternatively, for example, even when the sounding object is not detected/identified by the vision of the autonomous driving device, the sounding object may be detected/identified by the vision of the autonomous driving device.

The autonomous driving device determines a control parameter (S1020). The autonomous driving device may determine the control parameter based on the detected/identified sound and/or the detected/identified sounding object (or sounding location/direction).

For example, when the detected/identified sound is a horn sound, the location/direction of the sounding object may be detected/identified, and whether the horn sound is for the autonomous driving vehicle may be determined. When it is determined that the horn sound is for the autonomous driving vehicle, the control parameter for avoidance or braking may be determined based on the determination. For example, in this case, at least one of speed, acceleration, steering, and braking of the autonomous driving vehicle may be adjusted based on the control parameter. This can be applied similarly below.

As another example, if the detected/identified sound is a siren, it may be determined whether the sounding object is a police car or an emergency vehicle such as an ambulance or fire truck through the sounding object detection/identification. Alternatively, whether it is a police car siren sound or another emergency vehicle siren sound may be determined by using the detected/identified sound.

As another example, when the detected/identified sound is a call signal of the autonomous driving vehicle and the sounding object is a police car, the control parameter for braking of the autonomous driving vehicle may be determined. The call signal may include a sound indicating the vehicle by calling the number of the vehicle or by other methods. The call signal may also include a sound requesting the vehicle to stop.

As another example, if the detected/identified sound is a siren, even if the sounding object is not detected, the autonomous driving device may determine a control parameter for vehicle control based on the sounding location/direction. there is. Specifically, for example, a first control parameter may be generated when the sounding direction is opposite to that of the autonomous deriving vehicle, and a second control parameter may be generated when the sounding direction is in the same direction as the autonomous deriving vehicle. And, the first control parameter and the second control parameter may be different. Alternatively, as another example, based on the case where the sounding direction is in the same direction as the autonomous deriving vehicle, when the sounding location is located in front of the autonomous vehicle, a first control parameter is generated, and the sounding location is located behind autonomous driving vehicle, a second control parameter is generated, and the first control parameter and the second control parameter may be different.

The autonomous deriving device controls the autonomous deriving vehicle using the control parameter (S 1030). In this case, at least one of speed, acceleration, steering, and braking of the autonomous vehicle may be adjusted based on the control parameter. In addition, the emergency light of the autonomous deriving vehicle may be adjusted based on the control parameter.

Also, as described above, a machine learning model for an autonomous driving system requires significantly high accuracy for safety. For example, a machine learning model with 99% accuracy can be said to be very good, but it is difficult to guarantee the safety of an autonomous vehicle with 99% accuracy. However, in order to improve the 0.1% model from 99% to 99.1%, high complexity or a lot of trial and error is required. In addition, even if a high-accuracy model is used, it is difficult to avoid accidents depending on the situation.

For example, the following problematic situations may occur.

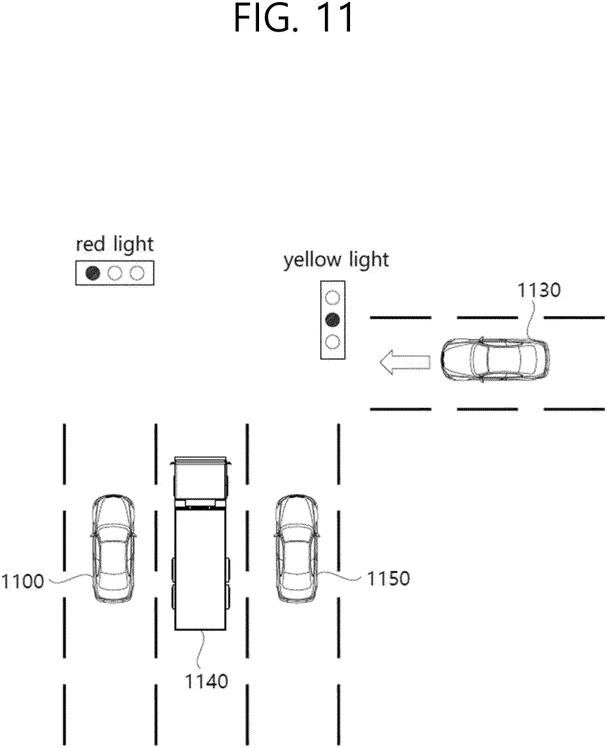

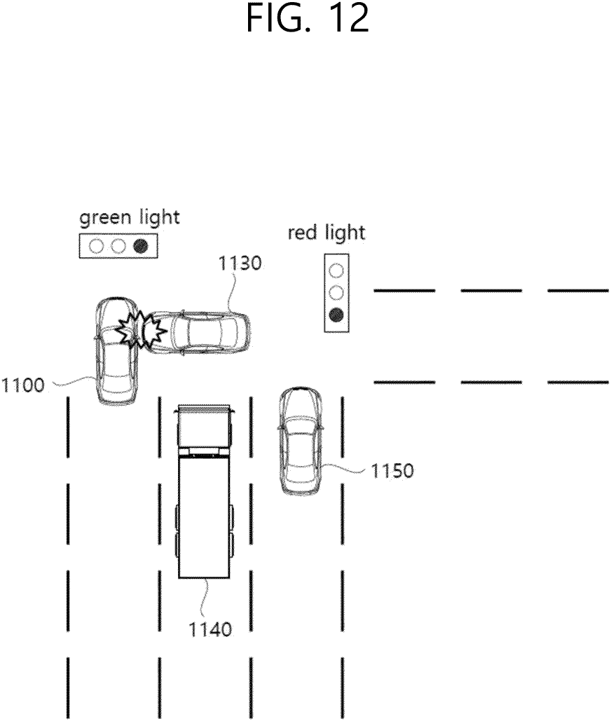

FIG. 11 and FIG. 12 show an example of a case where an autonomous driving vehicle does not recognize other vehicles on a driving route.

Referring to FIG. 11, an autonomous driving vehicle 1100 is stopped at a stop signal, and a vehicle 1130 enters an intersection at a time when the signal changes. In this case, the vehicle 1130 may be covered by the truck 1140 and not recognized by the autonomous driving vehicle 1100.

Therefore, as shown in FIG. 12, when the autonomous driving vehicle 1100 starts with the signal changed to blue (or green), it may collide with the vehicle 1130 that has late entered the intersection. In this case, since the truck 1140 or the vehicle 1150 can recognize the vehicle 1130, an accident can be prevented for them, but it is difficult for an autonomous driving vehicle 1100 to avoid an accident because it is difficult to recognize the vehicle 1130.

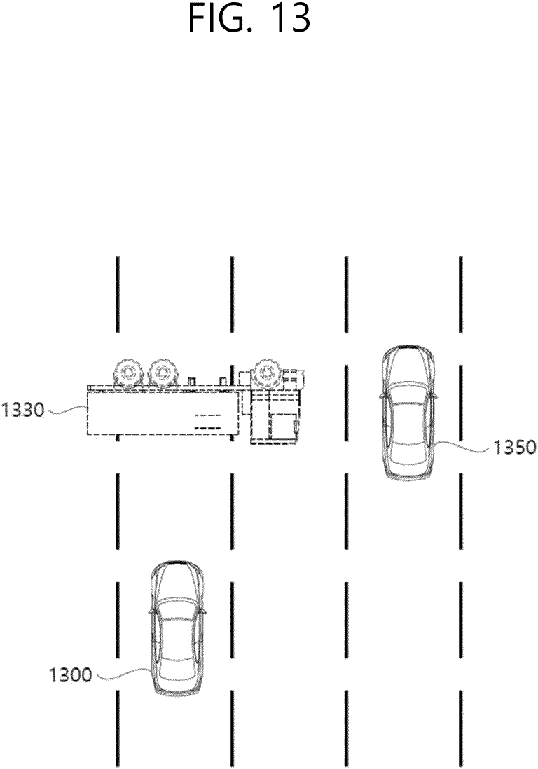

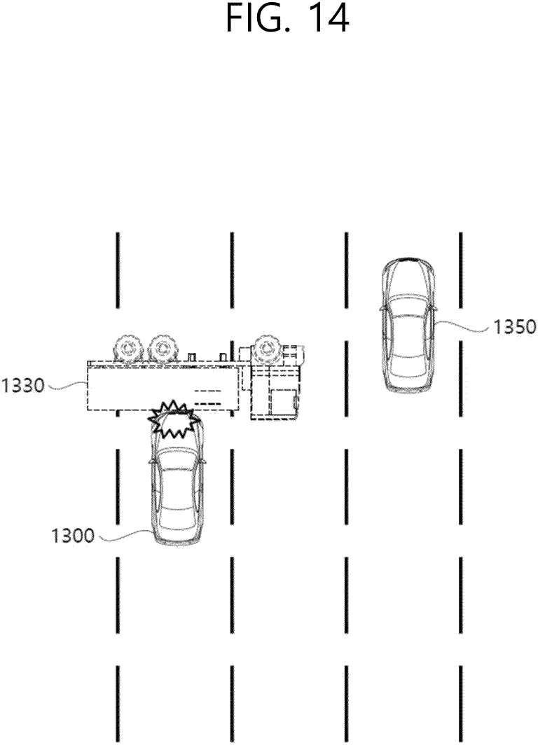

FIG. 13 and FIG. 14 show an example of not recognizing the overturned vehicle in front.

Referring to FIG. 13, when a truck 1330 is overturned or looking to the side in front of the driving direction of the autonomous driving vehicle 1300, the autonomous driving vehicle 1300 does not recognize the truck 1330. For example, when the container box of the truck 1330 is a bright color such as white, the autonomous driving device of the autonomous driving vehicle 1300 may mistakenly recognize the corresponding part as another object such as the sky.

In this case, as shown in FIG. 14, the autonomous driving vehicle 1300 may not recognize the truck 1330 and may collide with the truck 1330 without braking.

In one embodiment disclosed in this document, a vision pairing-based autonomous driving control method is proposed.

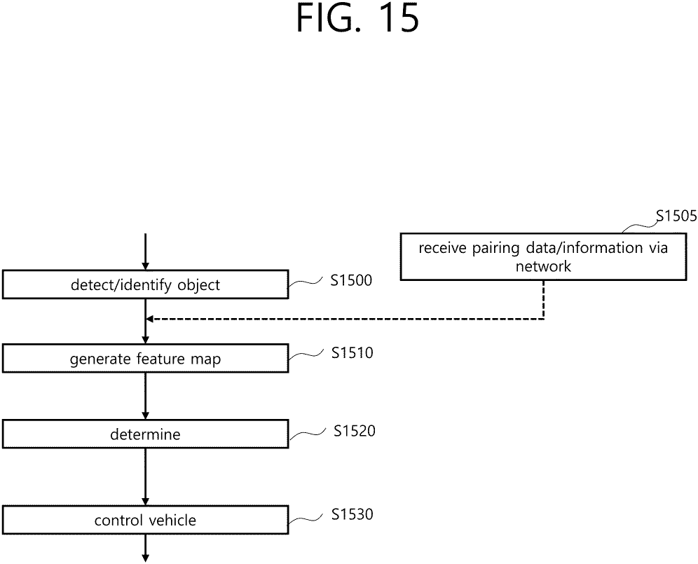

FIG. 15 exemplarily illustrates a vision pairing-based autonomous driving control method according to another embodiment. The method disclosed in FIG. 15 may be applied to the method disclosed in FIG. 3 or FIG. 4. S1500 to S1510 may be performed by the deep learning network or AI processor of FIG. 1. S1020 and S1030 may be performed by the AI processor and vehicle controller of FIG. 1. S1505 may be performed by the communicator of FIG. 1. S1510 or S1530 may be omitted. S1520 and S1530 can be integrated. An autonomous driving device may be provided in an autonomous driving vehicle.

Referring to FIG. 15, the autonomous driving device detects/identifies an object (S1500). Objects can be detected/identified and predicted through the trained machine learning model. In this case, the above-described sensor data may be used. Object information may include detected/identified/predicted information about the object. Here, identifying an object may include detecting the object and/or detecting a characteristic of the object. The characteristics of the object may include at least one of distance, position, speed, direction, size, shape, color, and type of the object. The type of object may indicate whether the object is one of candidates including a car, a bicycle, a person, a dog, or a cat. Alternatively, when the object is a car, the type of the object may indicate whether the object is one of candidates including a large truck, a passenger car, a police car, an ambulance, or a fire truck.

The autonomous driving device generates a feature map (S1510). The autonomous driving device may generate a feature map based on the detected/identified/predicted object. Feature maps may include 2D maps or 3D maps. The feature map may be represented based on a plan view or a perspective view. As described above, the feature map may schematically represent the surrounding environment. The feature map may include neighboring object information. The feature map may include, for example, information about detected neighboring vehicles, information about neighboring people, information about neighboring lanes, information about traffic lights, and the like.

The autonomous driving device receives pairing data/information through the network (S1505). The pairing data may include at least one of center data acquired from another vehicle, object identification information (including object characteristic information), and feature map information. The pairing data may be used interchangeably with pairing information. When the autonomous driving device is referred to as a first autonomous driving device, another autonomous driving device (hereinafter referred to as a second autonomous driving device) may obtain second object information from second sensor data. The second autonomous driving device may generate a second feature map based on the second object information. The pairing data may be used as an input of S1510, or may be combined with an output of S1500 or an output of S 1510. Communication based on the network includes one-way communication or two-way communication. For example, pairing data/information may be unicast. Alternatively, for example, pairing data/information may be broadcast together with position information of the corresponding vehicle. The first autonomous driving device may be called vehicle A, and the second autonomous driving device may be called vehicle B. Meanwhile, in this document, the second autonomous driving device (vehicle B) or a donor vehicle described later may be replaced with a base station or a road side unit (RSU).

For example, a pairing procedure according to an embodiment may be performed as follows.

For example, the first autonomous driving device may perform S1500 further based on the second sensor data.

As another example, the first autonomous driving device derives first object information based on the S 1500, and may derive modified/updated object information based on the received second object information and the derived first object information. In this case, the modified/updated object information may differ in at least one of the number and/or characteristics of objects included in the first object information. For example, information on a specific object derived from second object information may be reflected in the first object information to derive the modified/updated object information. Specifically, for example, when information on a detected specific car or specific person present in the second object information does not exist in the first object information (or exists but is contaminated or incomplete), information on the specific car or the specific person detected in the second object information is reflected in the first object information, and thus the modified/updated object information may be derived. For example, the first object information and/or the second object information may include object information about a specific area (eg, a pairing region).

As another example, the first autonomous driving device may derive a first feature map, and may derive modified/updated feature map information based on the received information on the second feature map and the information on the derived first feature map. Map information may also be derived. In this case, the modified/updated feature map may further include a specific object (or characteristic of the specific object) derived from the second feature map and not derived from the first feature map.

Meanwhile, a pairing procedure may be performed in consideration of transmission delay or signaling latency of the pairing information. For example, object information and/or object map (feature map) may be modified/updated in consideration of communication delay and/or signal processing delay between the first autonomous driving device and the second autonomous driving device. In this case, the object information and/or the object map may be modified/updated based on at least one of the delay time and the position, shape (size), speed and/or acceleration of the object detected in the second object information. For example, there is a case where a dt (ex. 1 ms to 50 ms) time delay occurs for transmission and/or processing of pairing information for a specific point in time t, and information on a specific object is included in the second object information. In this case, the position/shape of the specific object at the time t+dt may be calculated based on the position, velocity and dt of the specific object, and based on the position/shape of the specific object at the time t+dt, the modified/updated object information for the first autonomous driving device may be derived. The dt may correspond to a latency to be described later.

For example, as shown in the table below, communication may be restricted to be performed within a certain latency according to communication standards and services. For example, in the case of V2X messages, packet delay or latency may be controlled to occur within 5 ms, 10 ms, or 50 ms depending on the service.

TABLE 3

| 5QI Value | Resource Type | Default Priority Level | Packet Budget (NOTE 3) | Packet Error Rate | Default Maximum Data Burst Volume (NOTE 2) | Default Averaging Window | Example Services |
|---|---|---|---|---|---|---|---|
| 79 | | 65 | 50 ms (NOTE 10, NOTE 13) | 10⁻² | N/A | N/A | V2X messages (see TS 23.287 [121]) |
| 80 | | 88 | 10 ms (NOTE 5, NOTE 10) | 10⁻⁵ | N/A | N/A | Low Latency sMBB applications Augmented Reality |
| 82 | Delay critical GBR | 19 | 10 ms (NOTE 4) | 10⁻⁴ | 255 bytes | 2000 ms | Discrete Automation (see TS 22.261 [2]) |
| 83 | | 22 | 10 ms (NOTE 4) | 10⁻⁴ | 1354 bytes NOTE 3) | 2000 ms | Discrete Automation (see TS 22 261 [2]); V2X messages (UE -RSU Platooning. Advanced Driving: Cooperative Lane Change with low LoA. See TS 22.186 [111], TS 23.287 [121]) |
| 84 | | 24 | 30 ms (NOTE 6) | 10⁻⁵ | 1354 bytes (NOTE 3) | 2000 ms | Intelligent transport systems (see TS 22.281[2]) |
| 85 | | 21 | 5 ms (NOTE 5) | 10⁻⁶ | 255 bytes | 2000 ms | Electricity Distribution-high voltage (see TS 22.261 [2]) V2X messages (Remote Driving. See TS 22.186 [111], NOTE 16, see TS 23.267 [121]) |
| 86 | | 18 | 5 ms (NOTE 5) | 10⁻⁴ | 1354 bytes | 2000 ms | V2X messages (Advanced Driving: Collision Avoidance, Platooning with high LoA. See TS 22.186 [111], TS 23.287 [121]) |

In this case, the second object information acquired by the second autonomous driving device may be reflected on the first autonomous driving device in consideration of the unit processing time and communication delay (or latency) of the autonomous driving vehicle. That is, the object information and/or object map of the first autonomous driving device may be modified/updated. The unit processing time may include a frame time.

For example, the autonomous driving device may acquire surrounding images in frame units of M frame/sec. Here, M may include, for example, 30, 60, 120, 150, 180, 240, and the like. Based on the M, a time per frame (tpf) may be calculated. For example, if the transmission latency from the second autonomous driving device (or vehicle B) to the first autonomous driving device (or vehicle A) is L, based on at least one of L and threshold values th1 and/or th2, delay processing time can be calculated. For example, the delay processing time may be calculated according to whether L is less than or equal to the threshold values th1 and/or th2. For example, th1 may be smaller than 1tpf. th2 may be larger than 1tpf and smaller than 2tpf.

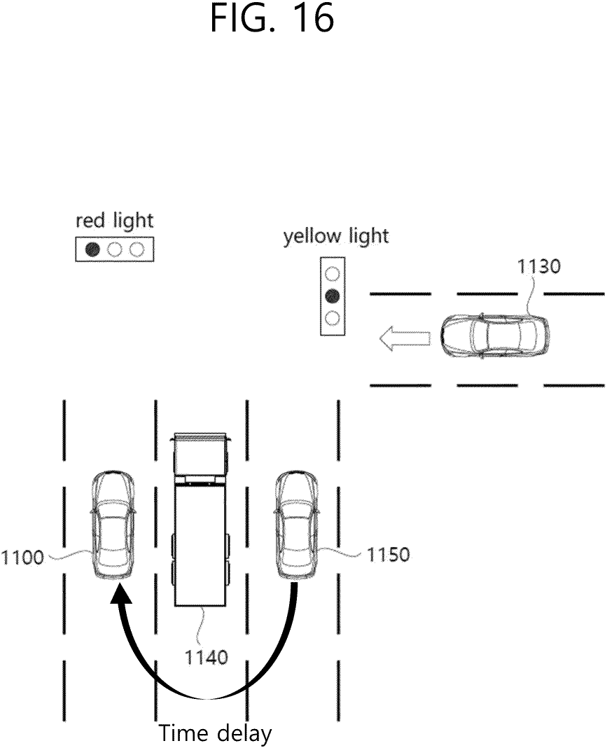

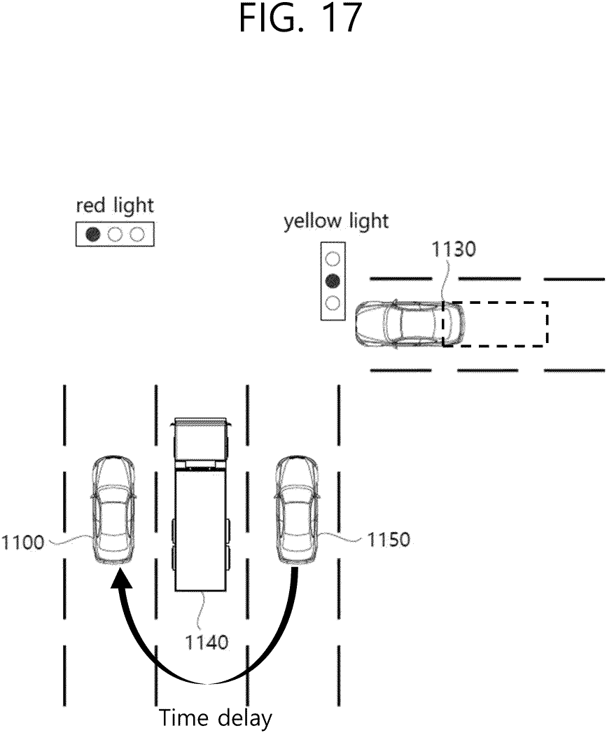

FIG. 16 and FIG. 17 illustratively show a time delay and a position difference of an object from a second autonomous driving device (or vehicle B) to a first autonomous driving device (or vehicle A). The time delay may include the aforementioned processing time and/or communication delay. The delay processing time may include the time delay.

Referring to FIG. 16 and FIG. 17, for example, the communication latency is L (ex. 5 ms to 50 ms), and the autonomous driving device may obtain a surrounding image in frame units of frame/sec, such as M (ex. 30, 60, 120, 240). For example, when a surrounding image is acquired/processed at 30 frames/sec, a time difference per frame (tpf) may be 33.3 ms. In this case, based on the variable L, if L is less than or equal to th1, the delay processing time may be calculated as a difference of 1 frame, and if L is greater than th1 and less than or equal to th2, the delay processing time may be calculated as a difference of 2 frames.

In other words, for example, the delay processing time may correspond to 1tpf when L is less than th1, and may correspond to 2tpf when L is greater than th1 and less than th2. When the L is greater than th2, the delay processing time may be 3tpf or may be set as unavailable.

In this case, the location of the specific object after a certain point in time can be derived/predicted based on the location, speed (and acceleration) of the specific object and the delay processing time. The delay processing time may be described as ntpf, for example. The delay processing time may simply be referred to as time delay dt.

In this case, for example, the location (position) of the specific object after a certain point in time can be calculated in the form of a vector as follows.

$${P}_{x} \left(t + n t p f\right) = {P}_{x t} + \left({v}_{x t} \times n t p f\right) \qquad \text{[Equation 1]}$$

$${P}_{y} \left(t + n t p f\right) = {P}_{y t} + \left({v}_{y t} \times n t p f\right) \qquad \text{[Equation 2]}$$

Here, (Pₓₜ,P_{yt}) may represent the x and y components of the object position at time t. (vₓₜ, v_{yt}) may represent the x and y components of the object’s velocity at time t. (Pₓ(t+ntpf), P_{y}(t+ntpf)) may represent the x and y components of the object position at the time point (t+ntpf).

Equations 1 and 2 may be expressed as follows.

$${P}_{x} \left(t + d t\right) = {P}_{x} \left(t\right) + \left({v}_{x} \left(t\right) \times d t\right) \qquad \text{[Equation 3]}$$

$${P}_{y} \left(t + d t\right) = {P}_{y} \left(t\right) + \left({v}_{y} \left(t\right) \times d t\right) \qquad \text{[Equation 4]}$$

Here, (Pₓ(t), P_{y}(t)) may represent the x and y components of the object position at time t. (vₓ(t), v_{y}(t)) may represent the x and y components of the object’s velocity at time t. (Pₓ(t+dt), P_{y}(t+dt)) may represent the x and y components of the object position at (t+dt).

Meanwhile, in order to more accurately predict the position of the object after the time delay, the acceleration of the object may be additionally considered. For example, acceleration can be calculated based on the difference in velocity of an object over time. The acceleration may be classified as (aₓ(t), a_{y}(t)) for each component.

When acceleration is further considered, the position of an object considering time delay may be derived/predicted as follows, for example.

$${P}_{x} \left(t + n t p f\right) = {P}_{x t} + \left({v}_{x t} + \frac{{a}_{x t} \times n t p f}{2}\right) \times \left(n t p f\right) \qquad \text{[Equation 5]}$$

$${P}_{y} \left(t + n t p f\right) = {P}_{y t} + \left({v}_{y t} + \frac{{a}_{x t} \times n t p f}{2}\right) \times \left(n t p f\right) \qquad \text{[Equation 6]}$$

Here, (aₓₜ, a_{yt}) may represent the x and y components of the object’s acceleration at time t.

$${P}_{x} \left(t + d t\right) = {P}_{x} \left(t\right) + \left({v}_{x} \left(t\right) + \frac{{a}_{x} \left(t\right) \times d t}{2}\right) \times \left(d t\right) \qquad \text{[Equation 7]}$$

$${P}_{y} \left(t + d t\right) = {P}_{y} \left(t\right) + \left({v}_{y} \left(t\right) + \frac{{a}_{y} \left(t\right) \times d t}{2}\right) \times \left(d t\right) \qquad \text{[Equation 8]}$$

Here, (aₓ(t), a_{y}(t)) may represent the x and y components of the object’s acceleration at time t.

For example, if the speed of an object is 100 km/s in a specific direction (ex. the x-axis direction) and 30 frames per second, the speed per frame in that direction is 27.778 m/s, and the amount of position change per frame can be 0.926 m. In this way, the position (location) information of the object may be updated in consideration of the delay.

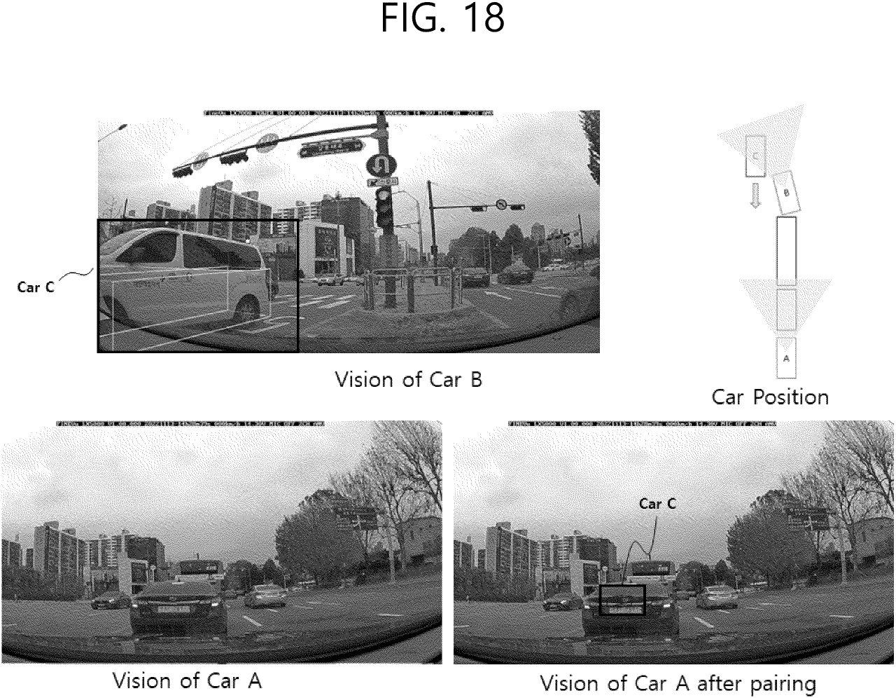

FIG. 18 illustrates an example of detecting/identifying an object vehicle based on vision pairing.

Referring to FIG. 18, vehicle A and vehicle B are located in a U-turn section, and vehicle C is approaching from the opposite lane. In this case, vehicle B is located at the front of the U-turn section, and vehicle A is located at the rear of the U-turn section. In the case of vehicle B, vehicle C coming from the opposite lane can be detected/identified. However, at the same time, vehicle A cannot detect/identify vehicle C because of the vehicles in front from the field of view of vehicle A. In this case, if a U-turn is attempted based only on the U-turn signal, there is a risk of colliding with vehicle C approaching from the opposite lane. On the other hand, when vision pairing according to the embodiment of this document is applied, by transmitting object information about vehicle C from vehicle B to vehicle A, vehicle A can also detect/identify vehicle C hidden by vehicles in front, accidents can be avoided by using it for vehicle control.

Meanwhile, the above-described pairing procedure may be performed based on a pairing region.

Based on the above-described pairing procedure, it is possible to derive vision expansion and accident prevention for autonomous driving vehicles.

Position information may be used for the pairing.

Position information between vehicle A and vehicle B may be based on position information of vehicle A and position information of vehicle B. Alternatively, the position information may be based on the distance information between vehicle A and vehicle B. Alternatively, the position information may be based on at least one of the position information of vehicle A, position information of vehicle B, or distance information between vehicle A and vehicle B. The position information may be based on absolute position information or relative position information of the vehicle A and vehicle B. The position information may be obtained based on at least one of GPS, map matching, vehicle image object detection, and communication.

The position of a vehicle (including vehicle A or vehicle B) may be based on global positioning coordinates or local positioning coordinates.

For example, if the position information of vehicle A and the position information of vehicle B are based on a coordinate system that shares the same origin and coordinate system (ex. global positioning coordinate system), The position information may be derived using the position information of vehicle A and the position information of vehicle B. That is, in this case, a pairing region and/or object characteristics (including position) may be specified using the position information of vehicle A and position information of vehicle B.

As another example, when the position information of vehicle A is based on a first local positioning coordinate system and the position information of vehicle B is based on a second local positioning coordinate system, at least one of the position information of vehicle A and the position information of vehicle B can be converted into the same coordinate system based on first coordinate conversion information between the first local positioning coordinate system and the global positioning coordinate system and second coordinate conversion information between the second local positioning coordinate system and the global positioning coordinate system. Through this, it is possible to specify the pairing region and/or object characteristics (including position). In this case, the second coordinate conversion information may be included in the pairing information and transmitted. However, the pairing information does not need to be transmitted every time, and may be transmitted at the initial stage of pairing or transmitted in advance.

Based on the pairing procedure, a feature map including first object information derived through sensor data of vehicle A and second object information derived through sensor data of vehicle B may be derived. In this case, a temporary feature map may be derived based on the first object information, and the feature map may be derived further based on the second object information. In this case, the final feature map may be called an updated feature map.

Alternatively, based on the pairing procedure, updated object information including first object information derived through sensor data of vehicle A and second object information derived through sensor data of vehicle B may be derived.

Alternatively, based on the pairing procedure, some of the sensor data of vehicle A and some of the sensor data of vehicle B may be combined, and based on this, object detection/identification may be performed through machine learning.

When the vehicle A and vehicle B are in a pairing mode, the vehicle B may be specified or displayed in the feature map of the vehicle A. For example, in the feature map of the vehicle A (or an image displayed based on the feature map), a display indicating that the vehicle A is paired with the vehicle B (eg, a highlight display on the vehicle outline) may be implemented. This also can be similarly applied to vehicle B.

When two vehicles are in a pairing state, one vehicle may be referred to as a donor vehicle and the other vehicle as a donee vehicle. Meanwhile, as described above, in this document, the donor vehicle may be replaced with a device other than a vehicle. For example, in this document, the pairing device for the donor may include other transportation means, a base station, an RSU, and the like. The donor vehicle is a pairing data/information providing vehicle. The donee vehicle may represent a pairing data/information receiving vehicle. When vehicle A and vehicle B are paired, one vehicle can be the donee and the other vehicle can be the donor. As another example, one vehicle may be both a donor and a donee at the same time, and another vehicle may be both a donor and a donee at the same time. For example, when vehicle B drives at least a certain distance ahead of vehicle A, vehicle B may operate only as a donee and vehicle A may operate only as a donor. For example, when vehicle B and vehicle A travel within a certain distance, both vehicle A and vehicle B may operate as donors and donees.

For example, whether to perform pairing may be determined based on a user interface. Alternatively, whether to pair may be determined based on a certain pairing trigger condition. For example, the pairing trigger condition may include at least one of the occurrence cases, for example, when the shaded area range of the vehicle (including vehicle A and/or vehicle B) exceeds a certain threshold value, when an object with accuracy of a certain level or less is identified, or when an object previously identified is not identified again for a certain period of time, if the vehicle is located at an intersection (ex. 3 streets or more), if the vehicle is located in front of a traffic light, if the vehicle finds an accident vehicle, or if other dangerous situations occur.

When the trigger is satisfied, the vehicle A may switch the vehicle mode to the pairing mode. In pairing mode, vehicle A can perform a pairing operation with another vehicle, vehicle B. For pairing, vehicle A may detect vehicle B, which is a pairing candidate vehicle, and may send a pairing request signal.

The autonomous driving device determines a control parameter (S 1520). The autonomous driving device may determine a control parameter based on (updated) object information or (updated) feature map.

The autonomous driving device controls the autonomous driving vehicle with the control parameter (S 1530). In this case, at least one of speed, acceleration, steering, and braking of the autonomous driving vehicle may be adjusted based on the control parameter. In addition, the emergency light of the autonomous driving vehicle may be adjusted based on the control parameter.

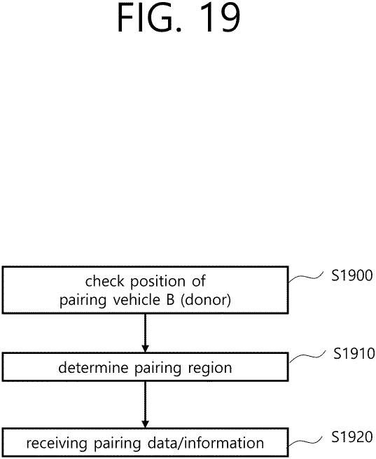

FIG. 19 shows an example of a pairing region-based pairing operation. FIG. 19 may represent operation in a donor vehicle.

For example, pairing vehicle B, which is a donor vehicle, may include vehicle 1150 in FIGS. 11 and 12. For example, pairing vehicle B may include vehicle 1350 in FIGS. 13 and 14.

The autonomous driving device of vehicle A may check the position of paired vehicle B (donor vehicle) (S1900), and derive location(position) information/distance information through it.

The autonomous driving device may determine a pairing region based on the location information/distance information (S1910). Pairing data/information is received based on the determined pairing region (S1920).

The autonomous driving device may detect/identify/predict additional objects for the pairing region based on the pairing data/information, and may derive (updated) object information or (updated) feature maps.

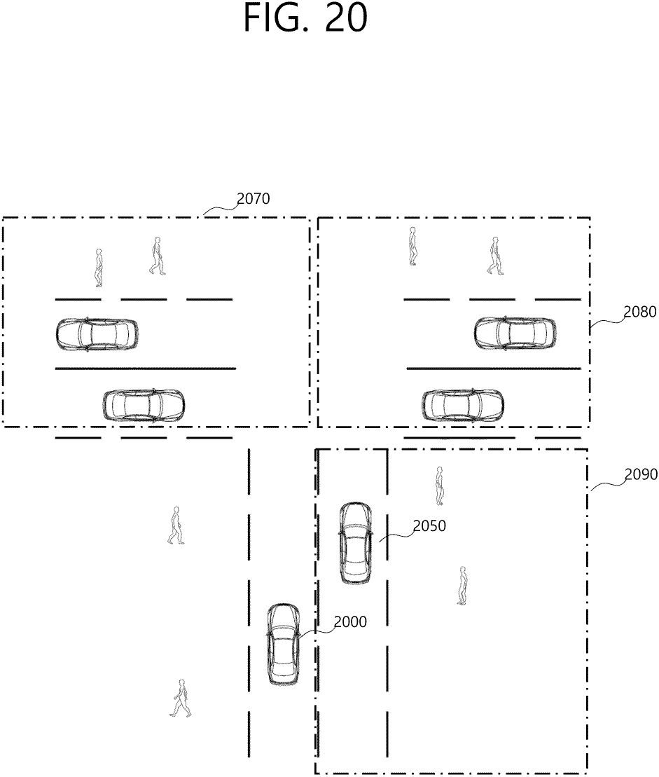

FIG. 20 exemplary shows a pairing region.

Referring to FIG. 20, for example, a vehicle 2000 may correspond to the aforementioned vehicle A, and a vehicle 2050 may correspond to the aforementioned vehicle B. For example, the region 2070, region 2080, and region 2090 represent examples of the pairing region. The pairing region may include one or more of the region 2070, region 2080, and region 2090.

The pairing region may be determined according to location information/distance information of vehicle A and vehicle B. The pairing region may be a rectangular area or a different shaped area. The shape/size of the pairing region may be determined differently depending on the location/distance between vehicle A and vehicle B. For example, the size of the pairing region may increase as the distance between vehicle A and vehicle B increases. As another example, the size of the pairing region may be smaller as the distance between vehicle A and vehicle B increases.

For example, when vehicle B is located on the upper right side (or first quadrant) of vehicle A, the pairing region may include at least one of the right, upper, and upper right regions of vehicle A. For example, when the vehicle B is located upper side the vehicle A, the fairing region may include at least one of an upper left region, an upper region, and an upper right region of the vehicle A. For example, when the vehicle B is located on the upper left side (or the second quadrant) of the vehicle A, the pairing region may include at least one of the upper region, the upper left region, and the left region of the vehicle A. For example, when the vehicle B is located to the left of the vehicle A, the pairing region may include at least one of an upper left region, a left region, and a lower left region of the vehicle A. For example, when the vehicle B is located on the lower left side (or the third quadrant) of the vehicle A, the pairing region may include at least one of the left region, the lower left region, and the lower region of the vehicle A. For example, when the vehicle B is located below side the vehicle A, the pairing region may include at least one of a lower left region, a lower region, and a lower right region of the vehicle A. For example, when the vehicle B is located on the lower right side (or the fourth quadrant) of the vehicle A, the pairing region may include at least one of the lower region, lower right region, and a right region of the vehicle A. For example, when the vehicle B is located on the right side of the vehicle A, the pairing region may include at least one of a lower right region, a right region, and an upper right region of the vehicle A.

For example, vehicle A may detect/identify vehicle C and vehicle D within the pairing region, and vehicle B may detect/identify vehicle C and vehicle E within the pairing region. For example, in this case, vehicle B may send information about vehicle C and vehicle E as pairing data/information, and in this case, vehicle A may update information about vehicle E that was not previously detected/identified through comparison. Also, vehicle A may further update information on vehicle C previously detected/identified through comparison. For example, the information about vehicle C may include the size, speed, acceleration, and direction of vehicle C.

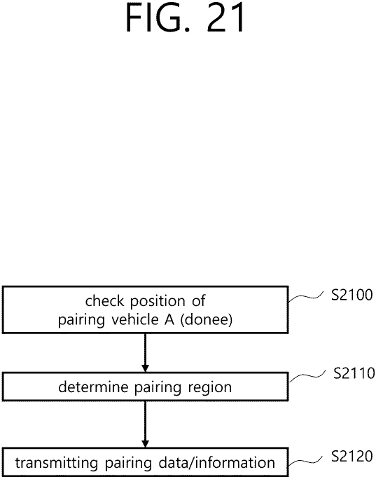

FIG. 21 shows an example of a pairing region-based pairing operation. FIG. 21 may show an operation in a donee vehicle.

For example, pairing vehicle A, which is a donee vehicle, may include vehicle 1100 in FIGS. 11 and 12. For example, pairing vehicle A may include vehicle 1300 in FIGS. 13 and 14.

The autonomous driving device of vehicle B may check the position of the paired vehicle A (donee vehicle) (S2100), and derive location information/distance information through it.

The autonomous driving device may determine a pairing region based on the location information/distance information (S2110). Pairing data/information is transmitted based on the determined pairing region (S2120).

The autonomous driving device may generate the pairing data/information based on the pairing region. For example, the pairing data/information may include object information within the pairing region.

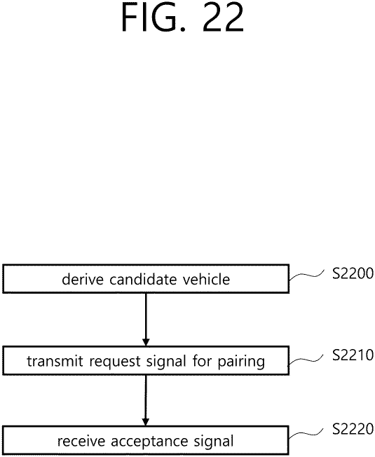

FIG. 22 shows an example of a pairing request and acceptance procedure.

The autonomous driving device of vehicle A derives a pairing candidate vehicle (S2200). In this case, a pairing candidate list including a plurality of candidate vehicles may be generated, and a specific candidate may be selected from the pairing candidate list. For example, as described above, vehicle A may derive the pairing candidate vehicle in pairing mode. As described above, the pairing mode may be determined based on a user interface or a pairing trigger condition.

The autonomous driving device of vehicle A transmits a pairing request signal (S2210). In pairing mode, vehicle A may perform a pairing operation with vehicle B, which is the pairing candidate vehicle. For pairing, vehicle A may detect vehicle B, which is a pairing candidate vehicle, and send a pairing request signal.

The autonomous driving device of vehicle A receives a pairing acceptance signal through the communicator (S2220). The pairing acceptance signal may be replaced with pairing data/information in some cases.

In some cases, S2200 and S2210 may be omitted. For example, if automatic pairing is set, a pairing acceptance signal or pairing data/information may be received directly from the pairing vehicle B. In this case, pairing vehicle B, which is a donee vehicle, may determine whether to pair with vehicle A.

Based on the above-described embodiments disclosed in this document, it is possible to recognize ambient sound as well as vision and control an autonomous vehicle based on it. In addition, safety and stability can be significantly increased through more accurate object identification.

In the foregoing embodiments, the methods are described based on a flow chart as a series of steps or blocks, but this document is not limited to the order of steps, and some steps may occur in a different order or concurrently with other steps as described above. Further, those skilled in the art will understand that the steps depicted in the flow charts are not exclusive, and that other steps may be included or one or more steps of the flow charts may be deleted without affecting the scope of this document.

The embodiments described in this document may be implemented and performed on a processor, microprocessor, controller, or chip. For example, functional units shown in each drawing may be implemented and performed on a computer, processor, microprocessor, controller, or chip. In this case, information for implementation (eg, information on instructions) or an algorithm may be stored in a digital storage medium.

Some embodiments may be implemented in the form of a recording medium including instructions executable by a computer, such as program modules executed by a computer. Computer readable media can be any available media that can be accessed by a computer and includes both volatile and nonvolatile media, removable and non-removable media. Also, computer readable media may include both computer storage media and communication media. Computer storage media includes both volatile and nonvolatile, removable and non-removable media implemented in any method or technology for storage of information such as computer readable instructions, data structures, program modules or other data. Communication media typically includes computer readable instructions, data structures, program modules, or other data in a modulated data signal such as a carrier wave, or other transport mechanism, and includes any information delivery media. Also, some embodiments may be implemented as a computer program or computer program product including instructions executable by a computer, such as a computer program executed by a computer.

In addition, the embodiments of this document may be implemented as a computer program product using program codes, and the program codes may be executed on a computer by the embodiments of this document. The program code may be stored on a carrier readable by a computer.

What is claimed is:

1. A method for controlling a vehicle based on an object identification, the method comprising:
obtaining sensor data based on sensors positioned on a vehicle;
performing object identification based on a result of applying the sensor data to a machine learning model;
adjusting a control parameter of the vehicle based on a result of the object identification,
wherein performing the object identification comprises:
receiving pairing data through a network,
wherein the object identification is performed further based on the pairing data.

2. The method of claim 1, wherein the pairing data include object information obtained from an external vehicle or an external device, and
wherein the object information includes information on at least one of a location, velocity, direction, size, shape, color or type of an object.

3. The method of claim 2, wherein the pairing data include object information on an object that is not identified from the sensor data obtained from the sensors positioned on the vehicle.

4. The method of claim 2, wherein a first object and a second object are identified through the performing the object identification,
wherein the first object is identified from the sensor data obtained from the sensors positioned on the vehicle, and the second object is identified from the pairing data, and
wherein the second object is different from the first object.

5. The method of claim 4, wherein based on (i) at least one of a location, velocity or acceleration of the second object at a first time point and (ii) a delay time between a second time point and the first time point, location information of the second object at the second time point is updated.

6. The method of claim 5, wherein the location information of the second object is updated based on the following equation,
$${P}_{x} \left(t + d t\right) = {P}_{x} \left(t\right) + \left({v}_{x} \left(t\right) + \frac{{a}_{x} \left(t\right) \times d t}{2}\right) \times \left(d t\right)$$
$${P}_{y} \left(t + d t\right) = {P}_{y} \left(t\right) + \left({v}_{y} \left(t\right) + \frac{{a}_{y} \left(t\right) \times d t}{2}\right) \times \left(d t\right)$$
where (Pₓ(t), P_{y}(t)) represents x, y components of the location of the second object at the first time point t, (vₓ(t), v_{y}(t)) represents x, y components of the velocity of the second object at the first time point t, (aₓ(t), a_{y}(t)) represents x, y components of the acceleration of the second object at the first time point t, (Pₓ(t+dt), P_{y}(t+dt)) represents x, y components of the location of the second object at the second time point, and dt represents the time delay.

7. The method of claim 1, wherein performing the object identification comprises:
identifying n objects from the sensor data;
identifying m objects from the pairing data; and
among m objects, updating k objects that are not overlapped with the n objects as valid objects.

8. The method of claim 1, further comprising:
deriving pairing device candidates neighboring the vehicle; and
transmitting pairing request signal to a specific device among the pairing device candidate;
wherein at least one of an acceptance signal or the pairing data is received from the specific device.

9. The method of claim 1, wherein the pairing data include object information obtained from a pairing device outside the vehicle,
wherein the method further comprising:
checking a location of the pairing device; and
determining a pairing region based on a location of the vehicle and the location of the pairing device,
wherein the pairing data include the object information on an object inside the pairing region.

10. The method of claim 9, further comprising:
generating feature map based on identified objects,
wherein the feature map is generated based on (i) object information on an object derived from the sensor data and (ii) object information on an object derived from the pairing data and located in the pairing region.

11. Non-transitory computer-readable storing medium storing information on instructions for execution on a processor, the instructions when executed by the processor cause the processor to:
obtain sensor data based on sensors positioned on a vehicle;
perform object identification based on a result of applying the sensor data to a machine learning model;
adjust a control parameter of the vehicle based on a result of the object identification,
wherein to perform the object identification, pairing data is received through a network,
wherein the object identification is performed further based on the pairing data.

12. The Non-transitory computer-readable storing medium of claim 11, wherein the pairing data include object information obtained from an external vehicle or an external device, and
wherein the object information includes information on at least one of a location, velocity, direction, size, shape, color or type of an object.

13. The Non-transitory computer-readable storing medium of claim 12, wherein the pairing data include object information on an object that is not identified from the sensor data obtained from the sensors positioned on the vehicle.

14. The Non-transitory computer-readable storing medium of claim 12, wherein a first object and a second object are identified through the performing the object identification,
wherein the first object is identified from the sensor data obtained from the sensors positioned on the vehicle, and the second object is identified from the pairing data, and
wherein the second object is different from the first object.

15. Non-transitory computer-readable storing medium of claim 14, wherein based on (i) at least one of a location, velocity or acceleration of the second object at a first time point and (ii) a delay time between a second time point and the first time point, location information of the second object at the second time point is updated.

16. Non-transitory computer-readable storing medium of claim 15, wherein the location information of the second object is updated is updated the following equation,
$${P}_{x} \left(t + d t\right) = {P}_{x} \left(t\right) + \left({v}_{x} \left(t\right) + \frac{{a}_{x} \left(t\right) \times d t}{2}\right) \times \left(d t\right)$$
$${P}_{y} \left(t + d t\right) = {P}_{y} \left(t\right) + \left({v}_{y} \left(t\right) + \frac{{a}_{y} \left(t\right) \times d t}{2}\right) \times \left(d t\right)$$
where (Pₓ(t), P_{y}(t)) represents x, y components of the location of the second object at the first time point t, (vₓ(t), v_{y}(t)) represents x, y components of the velocity of the second object at the first time point t, (aₓ(t), a_{y}(t)) represents x, y components of the acceleration of the second object at the first time point t, (Pₓ(t+dt), P_{y}(t+dt)) represents x, y components of the location of the second object at the second time point, and dt represents the time delay.

17. Non-transitory computer-readable storing medium of claim 11, wherein performing the object identification comprises:
identifying n objects from the sensor data;
identifying m objects from the pairing data; and
among m objects, updating k objects that are not overlapped with the n objects as valid objects.

18. Non-transitory computer-readable storing medium of claim 11, the instructions when executed by the processor further cause the processor to:
derive pairing device candidates neighboring the vehicle; and
transmit pairing request signal to a specific device among the pairing device candidate;
wherein at least one of an acceptance signal or the pairing data is received from the specific device.

19. Non-transitory computer-readable storing medium of claim 11, wherein the pairing data include object information obtained from a pairing device outside the vehicle,
the instructions when executed by the processor further cause the processor to:
check a location of the pairing device; and
determine a pairing region based on a location of the vehicle and the location of the pairing device,
wherein the pairing data include the object information on an object inside the pairing region.

20. A device for autonomous drive, the device comprising:
a pre-processor configured to obtain sensor data based on sensors positioned on a vehicle;
a deep learning network configured to perform object identification based on a result of applying the sensor data to a machine learning model, and
an artificial intelligent processor configured to adjust a control parameter of the vehicle based on a result of the object identification,
wherein the device further comprises a commuicator configured to receive parsing data through a network,
wherein the deep learning network is configured to perform the object identification further based on the pairing data.
